(19) United States
(12) Patent Application Publication
(10) Pub. No.: US 2025/0102704 A1
(43) Pub. Date: Mar. 27, 2025

(54) WAVEGUIDE PLATE, OPTICAL LENS ASSEMBLY AND ELECTRONIC DEVICE

(71) Applicant: LARGAN PRECISION CO., LTD., Taichung City (TW)

(72) Inventors: Chun-Ming CHEN, Taichung City (TW); Pi-Kuei SHIH, Taichung City (TW); Chun-Che HSUEH, Taichung City (TW); Yu Jie HONG, Taichung City (TW); Chun-Hung TENG, Taichung City (TW)

(21) Appl. No.: 18/800,379

(22) Filed: Aug. 12, 2024

(30) Foreign Application Priority Data
Sep. 26, 2023 (TW) 112136782

(51) Int. Cl. G02B 1/00; G02B 6/26

(52) U.S. Cl. CPC G02B 1/002; G02B 6/26

(57) ABSTRACT

A waveguide plate includes a substrate and at least two metasurfaces. The at least two metasurfaces are disposed on the substrate, wherein each of the metasurfaces includes at least two metastructure arrays, and the at least two metastructure arrays are linearly arranged. Each of the metastructure arrays includes at least two metastructure groups, and each of the metastructure groups includes at least two metastructures.

### RELATED APPLICATIONS

This application claims priority to Taiwan Application Serial Number 112136782, filed Sep. 26, 2023, which is herein incorporated by reference.

### BACKGROUND

### Technical Field

The present disclosure relates to an optical lens assembly and an electronic device. More particularly, the present disclosure relates to an optical lens assembly and an electronic device including a waveguide plate so as to increase the back focal length and reduce the size thereof.

### Description of Related Art

In order to meet the needs of the users, the magnification ratio of the optical lens assembly in the mobile phone is gradually increased. However, when the magnification ratio of the mobile phone is increased, the back focal length of the optical lens assembly is increased. Thus, the total length of the optical lens assembly is prone to exceed the thickness of the mobile phone, and the optical lens assembly cannot be accommodated inside the mobile phone. Further, although the periscope design can solve the problem that the optical lens assembly cannot be disposed inside the mobile phone, the periscope design of the optical lens assembly will compress the arrangement space of other elements in the mobile phone due to the increased magnification ratio.

Therefore, to increase the magnification ratio and reduce the size, it is necessary to actively develop the installation technology of the optical lens assembly that has both a high magnification ratio and a small size.

### SUMMARY

According to one aspect of the present disclosure, a waveguide plate includes a substrate and at least two metasurfaces. The at least two metasurfaces are disposed on the substrate, wherein each of the at least two metasurfaces includes at least two metastructure arrays, and the at least two metastructure arrays are linearly arranged. Each of the at least two metastructure arrays includes at least two metastructure groups, each of the at least two metastructure groups includes at least two metastructures, and each of the at least two metastructures is columnar. When a maximum adjacent center distance between the at least two metastructures is DmMax, and a maximum number of the metastructures in each of the metastructure groups is QmMax, the following condition is satisfied: DmMax×QmMax/1000≤3 nm-unit.

According to another aspect of the present disclosure, an optical lens assembly includes the waveguide plate according to the aforementioned aspect.

According to another aspect of the present disclosure, an electronic device includes the optical lens assembly according to the aforementioned aspect.

According to another aspect of the present disclosure, a waveguide plate includes a substrate and at least two metasurfaces. The at least two metasurfaces are disposed on the substrate, wherein each of the at least two metasurfaces includes at least two metastructure arrays, and the at least two metastructure arrays are linearly arranged. Each of the at least two metastructure arrays includes at least two metastructure groups, and each of the at least two metastructure groups includes at least two metastructures. When a height of each of the metastructures is Hm, and a refractive index of the substrate is Ns, the following conditions are satisfied: 400 nm<Hm; and Ns≤1.6.

According to another aspect of the present disclosure, an optical lens assembly includes the waveguide plate according to the aforementioned aspect.

According to another aspect of the present disclosure, an electronic device includes the optical lens assembly according to the aforementioned aspect.

### BRIEF DESCRIPTION OF THE DRAWINGS

The present disclosure can be more fully understood by reading the following detailed description of the embodiment, with reference made to the accompanying drawings as follows:

FIG. 1 is a side schematic view of a waveguide plate according to Example 1 of the present disclosure.

FIG. 2 is a plane schematic view of the waveguide plate of FIG. 1.

FIG. 3A is a top schematic view of a metastructure of the waveguide plate of FIG. 2.

FIG. 3B is a side schematic view of the metastructure of FIG. 3A.

FIG. 4 is a relationship diagram between the arrange order of metastructures and the radii of metastructures in the metastructure groups of the waveguide plate of Example 1.

FIG. 5 is a relationship diagram between the arrange order of metastructures and the radii of metastructures in the metastructure groups of the waveguide plate according to Example 2 of the present disclosure.

FIG. 6 is a relationship diagram between the arrange order of metastructures and the radii of metastructures in the metastructure groups of the waveguide plate according to Example 3 of the present disclosure.

FIG. 7 is a relationship diagram between the arrange order of metastructures and the radii of metastructures in the metastructure groups of the waveguide plate according to Example 4 of the present disclosure.

FIG. 8 is a relationship diagram between the arrange order of metastructures and the radii of metastructures in the metastructure groups of the waveguide plate according to Example 5 of the present disclosure.

FIG. 9 is a relationship diagram between the arrange order of metastructures and the radii of metastructures in the metastructure groups of the waveguide plate according to Example 6 of the present disclosure.

FIG. 10 is a relationship diagram between the arrange order of metastructures and the radii of metastructures in the metastructure groups of the waveguide plate according to Example 7 of the present disclosure.

FIG. 11 is a schematic view of an optical lens assembly according to Example 8 of the present disclosure.

FIG. 12 is a schematic view of an optical lens assembly according to Example 9 of the present disclosure.

### DETAILED DESCRIPTION

According to one embodiment of one aspect of the present disclosure, a waveguide plate includes a substrate and at least two metasurfaces. The at least two metasurfaces are disposed on the substrate, wherein each of the metasurfaces includes at least two metastructure arrays, and the at least two metastructure arrays are linearly arranged. Each of the metastructure arrays includes at least two metastructure groups, each of the metastructure groups includes at least two metastructures, and each of the metastructures is columnar. Therefore, by designing a specific configuration of the metastructures to form a phase difference in light and arranging the metastructure arrays in a specific design to form phase difference changes, the metasurfaces have the effect of increasing the deflection angle of passing light. When a waveguide plate including the metasurfaces is applied in the optical lens assembly, the light can be reflected back and forth inside the waveguide plate so as to achieve the folding of the optical path, so that the back focal length can be increased without increasing of the size of the optical lens assembly, and it is favorable for increasing the magnification ratio of the optical lens assembly and compressing the size thereof.

According to another embodiment of one aspect of the present disclosure, a waveguide plate includes a substrate and at least two metasurfaces. The at least two metasurfaces are disposed on the substrate, wherein each of the metasurfaces includes at least two metastructure arrays, and the at least two metastructure arrays are linearly arranged. Each of the metastructure arrays includes at least two metastructure groups, and each of the metastructure groups includes at least two metastructures. Therefore, by arranging the metastructure arrays in a specific design to form phase difference changes, the metasurfaces have the effect of increasing the deflection angle of passing light. When a waveguide plate including the metasurfaces is applied in the optical lens assembly, the light can be reflected back and forth inside the waveguide plate so as to achieve the folding of the optical path, so that the back focal length can be increased without increasing of the size of the optical lens assembly, and it is favorable for increasing the magnification ratio of the optical lens assembly and compressing the size thereof.

When a maximum adjacent center distance between the at least two metastructures is DmMax, and a maximum number of the metastructures in each of the metastructure groups is QmMax, the following condition can be satisfied: DmMax×QmMax/1000≤3 nm-unit. By limiting the maximum adjacent center distance between the metastructures and the maximum number of the metastructures in the metastructure group, it is favorable for increasing the deflection angle of passing light by the metasurfaces. Furthermore, the following condition can be satisfied: DmMax×QmMax/1000≤2.5 nm-unit. Furthermore, the following condition can be satisfied: DmMax×QmMax/1000≤2 nm-unit. By limiting the maximum adjacent center distance between the metastructures and the maximum number of the metastructures in the metastructure group, it is favorable for further increasing the deflection angle of passing light by the metasurfaces. Furthermore, the following condition can be satisfied: DmMax×QmMax/1000≤1.5 nm-unit. Furthermore, the following condition can be satisfied: DmMax×QmMax/1000≤1.25 nm-unit. Furthermore, the following condition can be satisfied: DmMax×QmMax/1000≤1.2 nm-unit. Furthermore, the following condition can be satisfied: 0 nm-unit<DmMax×QmMax/1000≤1.1 nm-unit.

When a height of each of the metastructures is Hm, the following condition can be satisfied: 400 nm<Hm. By satisfying the height of the metastructure, the phases of the metastructures that are sufficient to produce a delta phase variation can be ensured, and it is favorable for generating the deflection of light. Furthermore, the following condition can be satisfied: 450 nm≤Hm. Furthermore, the following condition can be satisfied: 500 nm≤Hm≤1000 nm. Furthermore, the following condition can be satisfied: 550 nm≤Hm≤900 nm.

When a refractive index of the substrate is Ns, the following condition can be satisfied: Ns≤1.6. By limiting the refractive index of the substrate, it is favorable for increasing the deflection angle of the passing light by the metasurfaces. Furthermore, the following condition can be satisfied: Ns≤1.55. Furthermore, the following condition can be satisfied: Ns≤1.51. Furthermore, the following condition can be satisfied: Ns≤1.50. Furthermore, the following condition can be satisfied: Ns≤1.48. Furthermore, the following condition can be satisfied: Ns≤1.46.

When the height of each of the metastructures is Hm, and a minimum metastructure radius of each of the metastructure groups is RgMin, the following condition can be satisfied: 4.7≤Hm/RgMin. By satisfying the ratio between the height of the metastructure and the minimum metastructure radius of the metastructure, a significant delta phase variation can be formed among the metastructures, and it is favorable for designing the deflection angle of passing light. Furthermore, the following condition can be satisfied: 5≤Hm/RgMin. Furthermore, the following condition can be satisfied: 10≤Hm/RgMin≤100. Furthermore, the following condition can be satisfied: 20≤Hm/RgMin≤80. Furthermore, the following condition can be satisfied: 30≤Hm/RgMin≤70. Furthermore, the following condition can be satisfied: 40≤Hm/RgMin≤60. Furthermore, the following condition can be satisfied: 45≤Hm/RgMin≤50.

When the height of each of the metastructures is Hm, and the maximum adjacent center distance between the at least two metastructures is DmMax, the following condition can be satisfied: 1.75<Hm/DmMax. By satisfying the ratio between the height of the metastructure and the maximum adjacent center distance between the metastructures, the density of the metastructures of the metasurface can be increased, the damage to the metasurfaces can be avoided, and it is favorable for enhancing the durability of the metasurface. Furthermore, the following condition can be satisfied: 1.8≤Hm/DmMax≤10. Furthermore, the following condition can be satisfied: 1.9≤Hm/DmMax≤5. Furthermore, the following condition can be satisfied: 2≤Hm/DmMax≤3.5. Furthermore, the following condition can be satisfied: 2.05≤Hm/DmMax≤3. Furthermore, the following condition can be satisfied: 2.1≤Hm/DmMax≤2.4.

When a maximum metastructure radius of each of the metastructure groups is RgMax, and the minimum metastructure radius of each of the metastructure groups is RgMin, the following condition can be satisfied: 1 RgMax/RgMin≤15. By designing a specific ratio between the maximum metastructure radius of the metastructure group and the minimum metastructure radius of the metastructure group, the phase difference among the metastructure groups can be reduced, and it is favorable for enhancing the stability of the deflection of light. Furthermore, the following condition can be satisfied: 3≤RgMax/RgMin≤13. Furthermore, the following condition can be satisfied: 4≤RgMax/RgMin≤12. Furthermore, the following condition can be satisfied: 5≤RgMax/RgMin≤9. Furthermore, the following condition can be satisfied: 6≤RgMax/RgMin≤8.

When a slope of radius of each of the metastructure groups is SlopR, the following condition can be satisfied: 1 nm/unit≤SlopR 50 nm/unit. By designing a specific slope of radius of the metastructure group, a change of the delta phase variation of the metastructure groups can be smooth, and it is favorable for further enhancing the stability of the deflection of light. Furthermore, the following condition can be satisfied: 5 nm/unit≤SlopR≤40 nm/unit. Furthermore, the following condition can be satisfied: 10 nm/unit≤SlopR≤35 nm/unit. Furthermore, the following condition can be satisfied: 20 nm/unit≤SlopR≤30 nm/unit. Furthermore, the following condition can be satisfied: 25 nm/unit s SlopR≤30 nm/unit.

When a deflection angle of passing light of each of the metasurfaces is Sd, the following condition can be satisfied: 5 degrees≤Sd. By designing a metasurface with a larger deflection angle, the total internal reflection is prone to be achieved in the waveguide plate so as to omit the arrangement of the reflective coating membrane, and it is favorable for streamlining the manufacturing process and reducing the production costs. Furthermore, the following condition can be satisfied: 10 degrees≤Sd. Furthermore, the following condition can be satisfied: 15 degrees≤Sd. Furthermore, the following condition can be satisfied: 18 degrees≤Sd. Furthermore, the following condition can be satisfied: 21 degrees≤Sd.

The waveguide plate of the present disclosure can include the substrate and the metasurface. The waveguide plate can include at least one metasurface, at least two metasurfaces, at least three metasurfaces or at least four metasurfaces. The plural metasurfaces can be defined as a first metasurface, a second metasurface, a third metasurface, a fourth metasurface, and so on.

The material of the substrate of the present disclosure can be the glass or the plastic material, and the elemental arrangement of the substrate can be a flat panel element or a prism. In response to different optical designs, the light reflection angle inside the substrate can be designed to be large enough to form a total internal reflection, a reflective coating membrane can be disposed on the surface of the substrate to facilitate the internal reflection of light inside the substrate, or an ink coating can be disposed on the surface of the substrate to absorb the stray light. When the reflective coating membrane and the ink coating are disposed simultaneously, the reflective coating membrane should be closer to the surface of the substrate than the ink coating.

The metasurface of the present disclosure is composed of the metastructure arrays, the metastructure array is composed of the metastructure groups, and the metastructure group is composed of the metastructures. The metasurface is composed of a plurality of metastructure arrays, and the plurality of metastructure arrays can include at least two metastructure arrays, at least three metastructure arrays or at least four metastructure arrays. The plurality of metastructure arrays can form a metasurface being circular, rectangular and polygonal, and the metasurfaces with various shapes can also be formed according to needs. The metasurfaces are distinguished by the arranging intervals of the metastructures. When the distance between the metastructure groups adjacent thereto is more than 1 μm, the metastructure groups can be regarded as belonging to different metasurfaces, and the distance between the metastructure groups adjacent thereto is calculated based on the central distance between the two metastructures nearest to each other.

The manufacturing technology of the metasurface of the present disclosure can be lithography, etching, electron beam lithography (EBL), focused ion beam etching, self-assembly, thermal nanoimprint lithography (T-NIL), ultraviolet nanoimprint lithography (UV-NIL), two-photon lithography (TPP), deposition, sol-gel method, or low-pressure chemical vapor deposition (LPCVD).

The arranging position of the metasurface of the present disclosure can be the image-side surface or the object-side surface of the substrate.

According to the effects of the metasurface of the present disclosure, the metasurface can be used to guide the wave (that is to change the direction of light travel) and can be used for polarization, refraction, diffraction, achromatic and anti-reflection, but the present disclosure is not limited thereto. By designing different surface shapes of the metasurfaces, different shapes of the metastructures, different heights of the metastructures, different radii of the metastructures and different adjacent center distances of metastructures, the various effects of the metasurface can be obtained.

The deflection angle (Sd) of passing light of the metasurface of the present disclosure refers to the angle difference between the angle of incidence on the air side and the exit angle on the waveguide plate side when the incident light passes through the metasurface from the air and then enters the inside of the waveguide plate at an angle of 0 degrees. The formula is that: Deflection angle=Exit angle on the waveguide plate side−Incident angle on the air side, wherein the angle of incidence is 0 degrees, so that the deflection angle=the exit angle on the waveguide plate side. The formula of the deflection angle is shown as follows: Sd=sin⁻¹{(WL/DmMax)/(m×Ns)}, wherein WL is wavelength, m=1/delta phase unit variation. When the imaging light passes through the metasurface having the metastructures thereof arranged relatively parallel, the deflected directions of all the lights are the same. For example, the metastructure arrays of the metasurface are arranged in a straight line from positive Y values to negative Y values, the metastructure arrays are arranged relatively parallel, and thus the incident light at the angle of 0 degrees will pass through the metasurface and then be deflected along the direction to the negative Y values. For example, the metastructure arrays of the metasurface are arranged in a straight line from positive X values to negative X values, the metastructure arrays are arranged relatively parallel, and thus the incident light at the angle of 0 degrees will pass through the metasurface and then be deflected along the direction to the negative X values.

According to the metastructure array of the present disclosure, the metasurfaces are distinguished based on the arrangement of the metastructure array and the relative arrangement of the metastructure array. The arrangement of the metastructure array refers to the arrangement of a single metastructure array and can be a linear arrangement, and the linear arrangement can be straight, non-straight or curved. The relative arrangement of the metastructure array refers to a relative arrangement among a plurality of metastructure arrays. The relative arrangement of the metastructure array can be parallel. When the imaging light passes through the metasurfaces where the metastructures are arranged relatively parallel to each other, the deflected directions of all the lights are the same. The relative arrangement of the metastructure array can be partially parallel or non-parallel. When the imaging light passes through the metasurfaces where the metastructures are arranged partially parallel or non-parallel, the deflected directions of all the lights are not exactly the same. The metastructure array is composed of a plurality of metastructure groups, and the plurality of metastructure groups can include at least two metastructure groups, at least three metastructure groups or at least four metastructure groups. The metastructure group of the present disclosure is composed of a plurality of metastructures, and the plurality of metastructures can include at least two metastructures, at least three metastructures or at least four metastructures.

The metastructures of one metastructure group are arranged in order from a small radius to a large radius, and thus the radius of the next metastructure will be greater than the radius of the previous metastructure. When the radius of the next metastructure of the metastructure array is smaller than the radius of the previous metastructure, it means that the next metastructure group has been entered.

The number of the metastructures of the metastructure group of the present disclosure refers to the number of all the metastructures included in one metastructure group, and the maximum number (QmMax) of the metastructures in the metastructure group is obtained from a maximum of the numbers of the metastructures in all of the metastructure groups in a metastructure array. When a number of the metastructures of each of the metastructure groups in a metastructure array is fixed, the maximum number of the metastructures of the metastructure group is the number of the metastructures of each of the metastructure groups.

The slope of radius (SlopR) of the metastructure group of the present disclosure refers to the slope of the radii of the metastructures in one metastructure group, and the formula thereof is SlopR=(RgMax−RgMin)/Im(interval), wherein “Im” refers to the number of intervals between the metastructure with the largest radius and the metastructure with the smallest radius in a metastructure group. For example, when the metastructure with the largest radius is the fifth metastructure in the metastructure group, and the metastructure with the smallest radius is the first metastructure in the metastructure group, Im=5−1=4.

The metastructure of the present disclosure refers to the smallest unit of the composition of a metasurface, and the metastructure is a nanometer (nm) level structure. At least one of the length, the width and the height of the metastructure is smaller than 1 μm. The material of the metastructure can be monocrystalline silicon, polycrystalline silicon, SiO, SiO₂, TiO, TiO₂, Si₃N₄, GaP, GaAs, AlSb, AlAs, AlGaAs, AlGaInP, BP, ZnGeP₂, etc., but the present disclosure is not limited thereto.

The surface shape of the metastructure of the present disclosure can be circular or polygonal. The side number of the polygon can be three, four, five, six, seven, eight or larger than eight. The surface shape of the metastructure is based on the top view shooting results of an electron microscope (SEM). The top view shooting means vertically photographing the waveguide plate which is laid flat, and the top surface shape of the metastructure can be seen in the top view shooting image. The top of the metastructure also refers to the opposite side of a contact surface between the metastructure and the substrate.

The shape of the metastructure of the present disclosure refers to a three-dimensional shape of the metastructure and can be conical or columnar. When the shape of the metastructure is approximately conical, it is regarded as conical, and when the shape of the metastructure is approximately columnar, it is regarded as columnar. For example, the metastructure can be a cone, a columnar, a quadrilateral pyramid or a hexagonal prism.

The height of the metastructure of the present disclosure refers to the maximum height of the metastructure calculated from the bottom thereof to the side away from the substrate.

The arranging direction of the metastructures of the present disclosure refers to the direction in which the radii of the metastructures in a metastructure group are arranged in order from small to large. The arranging direction of the metastructures is also the arranging direction of the metastructure groups and the direction of the metastructure arrays.

The adjacent center distance between the metastructure of the present disclosure refers to the distance between two metastructures adjacent thereto along the arranging direction of the metastructures, and the distance is calculated from the center of the metastructure arranged front along the arranging direction to the center of the metastructure arranged back along the arranging direction. The maximum adjacent center distance between the metastructure arrays refers to the maximum of the distances among the adjacent center distances of all the metastructures. The center of the metastructure is the intersection point of the longest diagonal line in the surface shape of the metastructure and the shortest diagonal line of the surface shape thereof. If the surface shape of the metastructure is round, the center of the circle is the center of the metastructure.

The radius of the metastructure of the present disclosure refers to the radius of the metastructure having a surface shape thereof being round.

The delta phase unit of the metastructure of the present disclosure is a value obtained from that the phase unit of each of the metastructures minus the phase unit of the first one of the metastructures of the metastructure group, and the delta phase unit variation is a value of the difference of the delta phases between the metastructures adjacent thereto.

Each of the aforementioned features of the waveguide plate of the present disclosure can be utilized in numerous combinations, so as to achieve the corresponding functionality.

According to one embodiment of another aspect of the present disclosure, an optical lens assembly includes the aforementioned waveguide plate.

The optical lens assembly can further include at least three optical lens elements, wherein the waveguide plate is disposed on an image side of the last one of the optical lens elements from an object side to an image side of an optical path. By arranging the waveguide plate on the back side of all the optical lens elements, the total optical length can be concentrated on the back focal length, so that it is favorable for enhancing the efficiency of the waveguide plate in compressing the back focal length.

When a field of view of the optical lens assembly is FOV, the following condition can be satisfied: FOV≤40 degrees. By satisfying the field of view of the optical lens assembly, the back focal length can be increased, and the efficiency of the waveguide plate in compressing the back focal length can be enhanced. Furthermore, the following condition can be satisfied: FOV≤30 degrees. Furthermore, the following condition can be satisfied: FOV≤20 degrees. Furthermore, the following condition can be satisfied: FOV≤15 degrees. Furthermore, the following condition can be satisfied: FOV≤12 degrees. Furthermore, the following condition can be satisfied: 0 degrees<FOV≤11.5 degrees.

When an angle of incidence on the waveguide plate of the optical lens assembly is AOI, the following condition can be satisfied: AOI≤30 degrees. Because the metasurface has a better deflection effect on light with small angle of incidences, by limiting the angle of incidence on the waveguide plate of the optical lens assembly, it is favorable for enhancing the imaging quality of the optical lens assembly. Furthermore, the following condition can be satisfied: AOI≤20 degrees. Furthermore, the following condition can be satisfied: AOI≤15 degrees. Furthermore, the following condition can be satisfied: AOI≤10 degrees. By reducing the angle at which the light exits each of the optical lens elements, it is favorable for further reducing the angle of incidence on the waveguide plate of the optical lens assembly. Furthermore, the following condition can be satisfied: 0 degrees<AOI≤8 degrees.

When a total focal length of the optical lens assembly is F, and a back focal length of the optical lens assembly BL, the following condition can be satisfied: F/BL≤1.3. By limiting the ratio between the focal length and the back focal length, it is favorable for enhancing the efficiency of the waveguide plate in compressing the back focal length. Furthermore, the following condition can be satisfied: F/BL≤2.5. Furthermore, the following condition can be satisfied: F/BL≤2. Furthermore, the following condition can be satisfied: F/BL≤1.5. Furthermore, the following condition can be satisfied: F/BL≤1.15. Furthermore, the following condition can be satisfied: 0<F/BL≤1.

The optical lens assembly can further include five optical lens elements, and the five optical lens elements are, in order from the object side to the image side of the optical path, a first optical lens element, a second optical lens element, a third optical lens element, a fourth optical lens element and a fifth optical lens element.

When a curvature radius of an object-side surface of the first optical lens element is R1, and a curvature radius of an image-side surface of the first optical lens element is R2, the following condition can be satisfied: |R1/R2|≤5. By satisfying the ratio between the curvature radius of the object-side surface of the first optical lens element and the curvature radius of the image-side surface thereof, it is favorable for reducing the angle at which the light exits the first optical lens element. Furthermore, the following condition can be satisfied: |R1/R2≤≤3. Furthermore, the following condition can be satisfied: |R1/R2|≤1. Furthermore, the following condition can be satisfied: 0<|R1/R2|≤0.5.

When a curvature radius of an object-side surface of the second optical lens element is R3, and a curvature radius of an image-side surface of the second optical lens element is R4, the following condition can be satisfied: |R3/R4|≤5. By satisfying the ratio between the curvature radius of the object-side surface of the second optical lens element and the curvature radius of the image-side surface thereof, it is favorable for reducing the angle at which the light exits the second optical lens element. Furthermore, the following condition can be satisfied: |R3/R4|≤3. Furthermore, the following condition can be satisfied: |R3/R4|≤1. Furthermore, the following condition can be satisfied: 0<|R3/R4|≤0.5.

When a curvature radius of an object-side surface of the third optical lens element is R5, and a curvature radius of an image-side surface of the third optical lens element is R6, the following condition can be satisfied: |R5/R6|≤5. By satisfying the ratio between the curvature radius of the object-side surface of the third optical lens element and the curvature radius of the image-side surface thereof, it is favorable for reducing the angle at which the light exits the third optical lens element. Furthermore, the following condition can be satisfied: |R5/R6|≤3. Furthermore, the following condition can be satisfied: 0<|R5/R6|≤1.

When a curvature radius of an object-side surface of the fourth optical lens element is R7, and a curvature radius of an image-side surface of the fourth optical lens element is R8, the following condition can be satisfied: |R7/R8|≤5. By satisfying the ratio between the curvature radius of the object-side surface of the fourth optical lens element and the curvature radius of the image-side surface thereof, it is favorable for reducing the angle at which the light exits the fourth optical lens element. Furthermore, the following condition can be satisfied: |R7/R8|≤3. Furthermore, the following condition can be satisfied: |R7/R8|≤1. Furthermore, the following condition can be satisfied: 0<|R7/R8|≤0.5.

When a curvature radius of an object-side surface of the fifth optical lens element is R9, and a curvature radius of an image-side surface of the fifth optical lens element is R10, the following condition can be satisfied: |R9/R10|≤5. By satisfying the ratio between the curvature radius of the object-side surface of the fifth optical lens element and the curvature radius of the image-side surface thereof, it is favorable for reducing the angle at which the light exits the fifth optical lens element. Furthermore, the following condition can be satisfied: |R9/R10|≤3. Furthermore, the following condition can be satisfied: |R9/R10|≤1. Furthermore, the following condition can be satisfied: 0<|R9/R10|≤0.5.

The angle of incidence (AOI) on the waveguide plate of the optical lens assembly of the present disclosure optical lens assembly refers to the angle of incidence of the chief ray on the air side at 1.0 Field when the imaging light of the optical lens assembly enters the waveguide plate from the air.

In the aspect of the object side and the image side of the optical lens assembly of the present disclosure, when the optical lens assembly images by the image sensor, the side close to the image sensor along the optical path is the image side, and the side away from the image sensor along the optical path is the object side. When the optical lens assembly images in the eyes of the user, the side close to the eyes of the user along the optical path is the image side, and the side away from the eyes of the user along the optical path is the object side.

The number of the optical lens elements of the present disclosure optical lens assembly can be at least one, at least two, at least three, at least four, at least five, at least six, at least seven, at least eight, at least nine and at least ten. The optical lens elements can be, in order from the object side to the image side, a first optical lens element, a second optical lens element, a third optical lens element, a fourth optical lens element, a fifth optical lens element, a sixth optical lens element, seventh optical lens element, an eighth optical lens element, a ninth optical lens element, a tenth optical lens element, etc.

The curvature radius of the optical lens element of the present disclosure refers to the curvature radius of the object-side surface of the optical lens element or the curvature radius of the image-side surface of the optical lens element.

The waveguide plate of the optical lens assembly of the present disclosure can be disposed between the first optical lens element and the second optical lens element, between the second optical lens element and the third optical lens element, between the third optical lens element and the fourth optical lens element, between the fourth optical lens element and the fifth optical lens element, between the fifth optical lens element and the sixth optical lens element, between the sixth optical lens element and the seventh optical lens element, between the seventh optical lens element and the eighth optical lens element, between the eighth optical lens element and the ninth optical lens element, between the ninth optical lens element and the tenth optical lens element, on the image-side surface of the tenth optical lens element, or on the image-side surface of the last of the optical lens elements. The object side and the image side of the waveguide plate can be arranged with the optical lens element, and the object side and the image side of the waveguide plate can be arranged with at least one optical lens element, at least two optical lens elements, at least three optical lens elements, at least four optical lens elements or at least five optical lens elements.

According to one embodiment of another aspect of the present disclosure, an electronic device includes the aforementioned optical lens assembly. Therefore, the imaging quality can be effectively enhanced. Preferably, the electronic device can further include but not be limited to a control unit, a display, a storage unit, a random-access memory (RAM), a read-only memory (ROM), or the combination thereof. Furthermore, the electronic device of the present disclosure can be a mobile device or a head-mounted device. The mobile device can be a cell phone, a tablet, a laptop, a video camera, a camera, a webcam, etc. The head-mounted device can be an AR glasses, a VR glasses, an AR head-mounted display, a VR head-mounted display, etc.

According to the above descriptions, the specific embodiments and reference drawings thereof are given below so as to describe the present disclosure in detail.

### Example 1

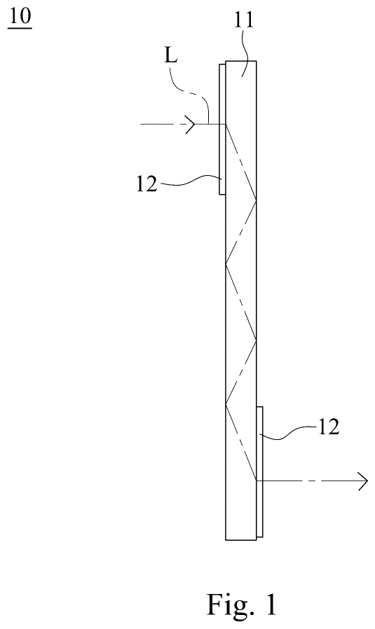

Reference is made to FIG. 1, and FIG. 1 is a side schematic view of a waveguide plate 10 according to Example 1 of the present disclosure. The waveguide plate 10 of Example 1 includes a substrate 11 and at least two metasurfaces 12, and the at least two metasurfaces 12 are disposed on the substrate 11. As shown in FIG. 1, the two metasurfaces 12 are respectively disposed on two surfaces of the substrate 11. When the light L is incident to the waveguide plate 10 of Example 1, the light L will enter one of the metasurfaces 12 and then into the substrate 11, the optical path folding can be achieved after multiple back-and-forth reflections in the substrate 11 of the light L, and then the light L exists the substrate 11 from the other one of the metasurfaces 12. Because the delta phase of the light L can be generated by the metasurfaces 12, and the deflection angle of passing light of the light L will be increased due to the change in the delta phase caused by the metasurfaces 12, thereby achieving the corresponding effects.

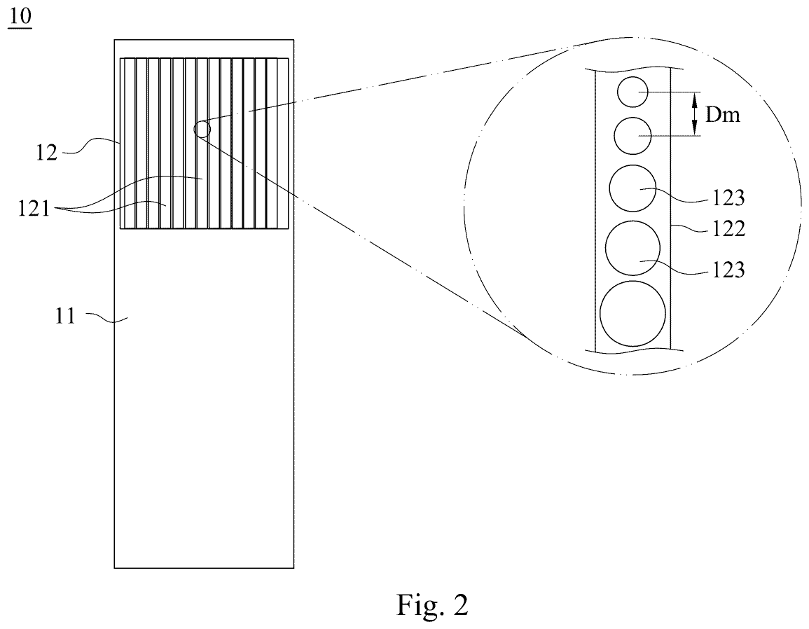

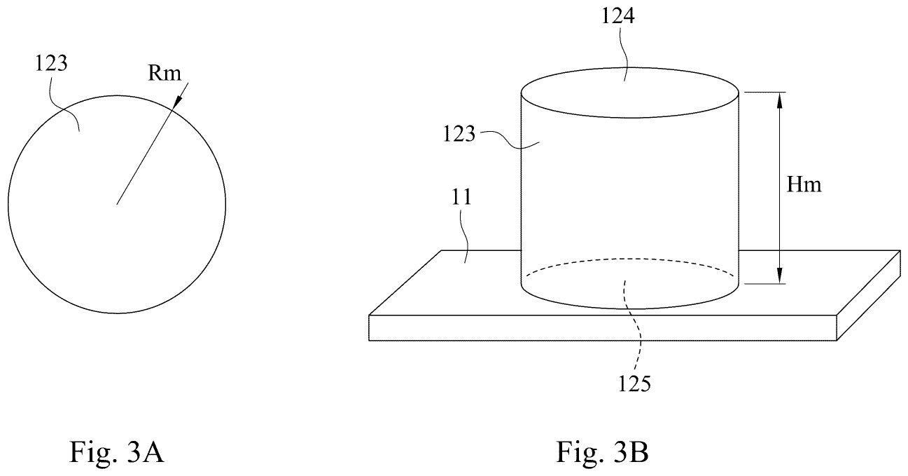

Reference is further made to FIG. 2, FIG. 3A and FIG. 3B. FIG. 2 is a plane schematic view of the waveguide plate 10 of FIG. 1, FIG. 3A is a top schematic view of a metastructure 123 of the waveguide plate 10 of FIG. 2, and FIG. 3B is a side schematic view of the metastructure 123 of FIG. 3A. As shown in FIG. 2, the metasurface 12 includes at least two metastructure arrays 121, and the at least two metastructure arrays 121 are linearly arranged. Each of the metastructure arrays 121 includes at least two metastructure groups 122 (there are only two metastructure groups 122 marked in FIG. 2), and each of the metastructure groups 122 includes at least two metastructures 123 (there are only two metastructures 123 marked in FIG. 2), wherein the metastructures 123 in a single metastructure group 122 are arranged in order, and there is an adjacent center distance Dm between two of the metastructures 123 adjacent thereto. As shown in FIG. 3A and FIG. 3B, the surface of the metastructure 123 is round, and thus the radius Rm of the metastructure 123 of Example 1 is measured based on the circle. Further, the height Hm of the metastructure 123 is the straight-line distance from the top surface 124 of the metastructure 123 to the bottom surface 125 of the metastructure 123.

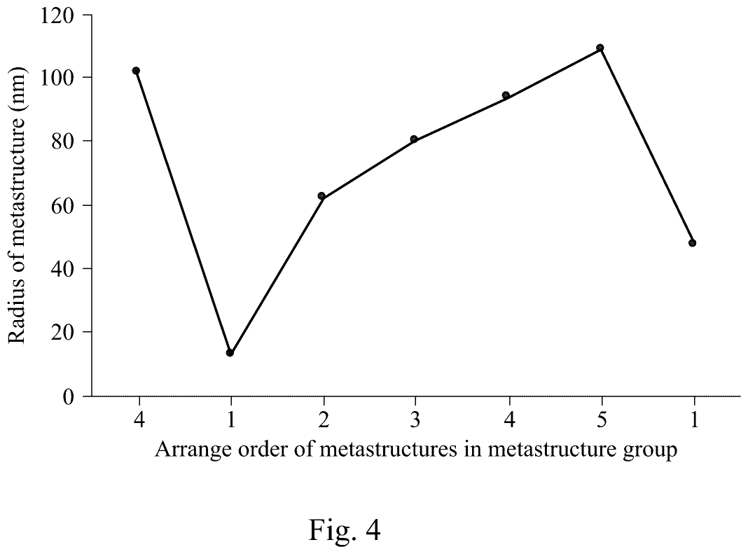

Reference is further made to FIG. 3A, FIG. 3B, FIG. 4 and Table 1, wherein FIG. 4 is a relationship diagram between the arrange order of metastructures 123 and the radii of metastructures 123 in the metastructure groups 122 of the waveguide plate 10 of Example 1, and Table 1 shows the properties of the waveguide plate 10 of Example 1.

TABLE 1

| Arrange pattern of | Straight line | | | | | | |
|---|---|---|---|---|---|---|---|
| metastructure arrays | | | | | | | |
| Relative arrange pattern | Parallel | | | | | | |
| of metastructure arrays | | | | | | | |
| Arrange order of | 4 | 1 | 2 | 3 | 4 | 5 | 1 |
| metastructures in | | | | | | | |
| metastructure group | | | | | | | |
| Delta phase unit variation | 0.22125 | | | | | | |
| DmMax (nm) | 260 | 260 | 260 | 260 | 260 | 260 | 260 |
| QmMax (unit) | 5 | | | | | | |
| Delta phase unit | 0.77875 | 0 | 0.22125 | 0.4425 | 0.66375 | 0.885 | 0.10625 |
| Hm (nm) | 600 | 600 | 600 | 600 | 600 | 600 | 600 |
| Rm (nm) | 101.6 | 13.0 | 62.4 | 80.0 | 94.1 | 108.8 | 47.9 |
| RgMax (nm) | — | 108.8 | | | | | — |
| RgMin (nm) | — | 13 | | | | | — |
| DmMax × QmMax/1000 | 1.30 | | | | | | |
| (nm · unit) | | | | | | | |
| Hm/RgMin | 46.2 | | | | | | |
| Hm/DmMax | 2.31 | 2.31 | 2.31 | 2.31 | 2.31 | 2.31 | 2.31 |
| RgMax/RgMin | — | 8.4 | | | | | — |
| SlopR (nm/unit) | — | 24.0 | | | | | — |
| Material of metastructure | TiO₂ | TiO₂ | TiO₂ | TiO₂ | TiO₂ | TiO₂ | TiO₂ |
| Nm | 2.6142 | 2.6142 | 2.6142 | 2.6142 | 2.6142 | 2.6142 | 2.6142 |
| Material of substrate | SiO₂ | SiO₂ | SiO₂ | SiO₂ | SiO₂ | SiO₂ | BSC₇ |
| Ns | 1.4585 | 1.4585 | 1.4585 | 1.4585 | 1.4585 | 1.4585 | 1.4585 |
| Sd (degrees) | 20 | 20 | 20 | 20 | 20 | 20 | 20 |

In Table 1, “Arrange order of metastructures in metastructure group” refers to the metastructures 123 arranged in order in one metastructure group 122. As shown in FIG. 2, the five metastructures 123 from top to bottom are represented by the numbers 1 to 5 in Table 1, wherein DmMax is a maximum adjacent center distance between the at least two metastructures 123, QmMax is a maximum number of the metastructures 123 in the metastructure group 122, Hm is a height of the metastructure 123, Rm is a radius of the metastructure 123, RgMax is a maximum metastructure radius of the metastructure group 122, RgMin is a minimum metastructure radius of the metastructure group 122, SlopR is a slope of radius of the metastructure group 122, Nm is a refractive index of the metastructure 123, Ns is a refractive index of the substrate 11, and Sd is a deflection angle of passing light of the metasurface 12.

The wavelength used in waveguide plate 10 of Example 1 is 587.6 nm, and the delta phase unit variation is fixed at 0.22125 unit. Therefore, dividing 1 unit by 0.22125 (delta phase unit variation) can get a value between 4.519-4.520 (1/0.22125=4.52, that is the “m” in the formula of the deflection angle), the number of the metastructures 123 of the metastructure group 122 in the metastructure array 121 will change between 4 and 5, and thus the numbers of the metastructures 123 of the metastructure group 122 in the metastructure array 121 of Example 1 are 4 and 5. Because the number of the metastructures 123 of the metastructure group 122 is taken as the maximum number of 5, the maximum number of the metastructures 123 of the metastructure group 122 is 5. Further, in Table 1, the first one of the metastructure groups 122 having the delta phase unit of the metastructure 123 being 0 of Example 1 is used to present the results (that is the metastructure group 122 having five metastructures 123), and the previous one of the metastructure groups 122 having five metastructures 123 has four metastructures 123 (as shown in the value corresponding to the first of the number 4 in the left column of “Arrange order of metastructures in metastructure group” in Table 1).

In Example 1, when the arranging direction of the metastructures 123 is fixed, starting from the metastructure 123 with a radius of 13 nm, the radii of the metastructures 123 are 13 nm, 62.4 nm, 80.0 nm, 94.1 nm, 108.8 nm and 47.9 nm in sequence, wherein the radii of the first five metastructures 123 all meet the condition that the radius of the latter metastructure 123 is greater than the radius of the previous metastructure 123, and thus the previous five metastructures 123 belong to a single of the metastructure group 122. The radius of the sixth metastructure 123 is smaller than the radius of the fifth metastructure 123, so the sixth metastructure 123 does not belong to the metastructure group 122 of the previous five metastructures 123. Further, in Example 1, all of the delta phase units of metastructures 123 are obtained by minus the phase unit of the first metastructure 123 with the radius of 13 nm. Accordingly, for the first metastructure 123 with the radius of 13 nm, the delta phase unit is 0, the delta phase unit of the second metastructure 123 is 0.22125, and the delta phase unit of the second metastructure 123 minus the delta phase unit of the first metastructure 123 is 0.22125. Thus, the delta phase unit variation is 0.22125.

It must be noted that the number and the arranging position of the metasurfaces 12 are not limited to the disclosure shown in FIG. 1, and the metasurfaces 12 can be disposed on different positions of the substrate 11 according to needs. Further, the configurations of the metastructure array 121, the metastructure group 122 and the metastructure 123 of FIG. 1 are for illustration only, and the present disclosure is not limited to the disclosure shown in the drawings.

If the definitions of parameters shown in tables of the following examples are the same as those shown in Table 1, those will not be described again.

### Example 2

The waveguide plate of Example 2 includes a substrate and at least two metasurfaces. The at least two metasurfaces are disposed on the substrate, each of the metasurfaces includes at least two metastructure arrays, and at least two metastructure arrays are linearly arranged. Each of the metastructure arrays includes at least two metastructure groups, and each of the metastructure groups includes at least two metastructures. Further, the waveguide plate of Example 2 is similar in structure to the waveguide plate 10 of Example 1, and the difference is that the numbers of the metastructures are different. Thus, the details of the structures are referred to the waveguide plate 10 of Example 1, and those will not be described again herein.

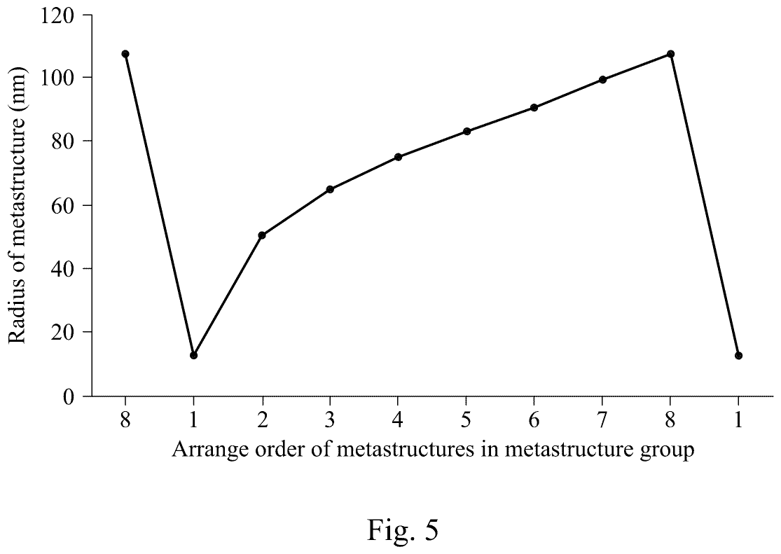

Reference is made to FIG. 5 and Table 2 simultaneously. FIG. 5 is a relationship diagram between the arrange order of metastructures and the radii of metastructures in the metastructure groups of the waveguide plate according to Example 2 of the present disclosure, and Table 2 shows the properties of the waveguide plate of Example 2 and the values of DmMax, QmMax, Hm, Rm, RgMax, RgMin, DmMax×QmMax/1000, Hm/RgMin, Hm/DmMax, RgMax/RgMin, SlopR, Nm, Ns and Sd. In Table 2, “Arrange order of metastructures in metastructure group” refers to the metastructures arranged in order in one metastructure group, and the numbers 1 to 8 represent the eight metastructures arranged in order in one metastructure group of Example 2 and the values thereof.

TABLE 2

| Arrange pattern of | Straight line | | | | | | | | | |
|---|---|---|---|---|---|---|---|---|---|---|
| metastructure arrays | | | | | | | | | | |
| Relative arrange pattern | Parallel | | | | | | | | | |
| of metastructure arrays | | | | | | | | | | |
| Arrange order of | 8 | 1 | 2 | 3 | 4 | 5 | 6 | 7 | 8 | 1 |
| metastructures in | | | | | | | | | | |
| metastructure group | | | | | | | | | | |
| Delta phase unit variation | 0.125 | | | | | | | | | |
| DmMax (nm) | 260 | 260 | 260 | 260 | 260 | 260 | 260 | 260 | 260 | 260 |
| QmMax (unit) | 8 | | | | | | | | | |
| Delta phase unit | 0.875 | 0 | 0.125 | 0.25 | 0.375 | 0.5 | 0.625 | 0.75 | 0.875 | 0 |
| Hm (nm) | 600 | 600 | 600 | 600 | 600 | 600 | 600 | 600 | 600 | 600 |
| Rm (nm) | 108.0 | 13.0 | 50.7 | 65.2 | 75.4 | 83.6 | 91.0 | 99.8 | 108.0 | 13.0 |
| RgMax (nm) | 108 | | | | | | | | | |
| RgMin (nm) | 13 | | | | | | | | | |
| DmMax × QmMax/1000 | 2.08 | | | | | | | | | |
| (nm · unit) | | | | | | | | | | |
| Hm/RgMin | 46.2 | | | | | | | | | |
| Hm/DmMax | 2.31 | 2.31 | 2.31 | 2.31 | 2.31 | 2.31 | 2.31 | 2.31 | 2.31 | 2.31 |
| RgMax/RgMin | 8.3 | | | | | | | | | |
| SlopR (nm/unit) | 13.6 | | | | | | | | | |
| Material of metastructure | TiO₂ | TiO₂ | TiO₂ | TiO₂ | TiO₂ | TiO₂ | TiO₂ | TiO₂ | TiO₂ | TiO₂ |
| Nm | 2.6142 | 2.6142 | 2.6142 | 2.6142 | 2.6142 | 2.6142 | 2.6142 | 2.6142 | 2.6142 | 2.6142 |
| Material of substrate | SiO₂ | SiO₂ | SiO₂ | SiO₂ | SiO₂ | SiO₂ | SiO₂ | SiO₂ | SiO₂ | SiO₂ |
| Ns | 1.4585 | 1.4585 | 1.4585 | 1.4585 | 1.4585 | 1.4585 | 1.4585 | 1.4585 | 1.4585 | 1.4585 |
| Sd (degrees) | 11.2 | 11.2 | 11.2 | 11.2 | 11.2 | 11.2 | 11.2 | 11.2 | 11.2 | 11.2 |

The wavelength used in waveguide plate of Example 2 is 587.6 nm, and the delta phase unit variation is fixed at 0.125 unit. Therefore, dividing 1 unit by 0.125 can get 8 (1/0.125=8), 1 is divisible by 0.125, thus the numbers of the metastructures of the metastructure groups in one metastructure array of Example 2 are 8, and the maximum number of the metastructures in the metastructure group is 8.

### Example 3

The waveguide plate of Example 3 includes a substrate and at least two metasurfaces. The at least two metasurfaces are disposed on the substrate, each of the metasurfaces includes at least two metastructure arrays, and at least two metastructure arrays are linearly arranged. Each of the metastructure arrays includes at least two metastructure groups, and each of the metastructure groups includes at least two metastructures. Further, the waveguide plate of Example 3 is similar in structure to the waveguide plate 10 of Example 1, and the difference is that the numbers of the metastructures are different. Thus, the details of the structures are referred to the waveguide plate 10 of Example 1, and those will not be described again herein.

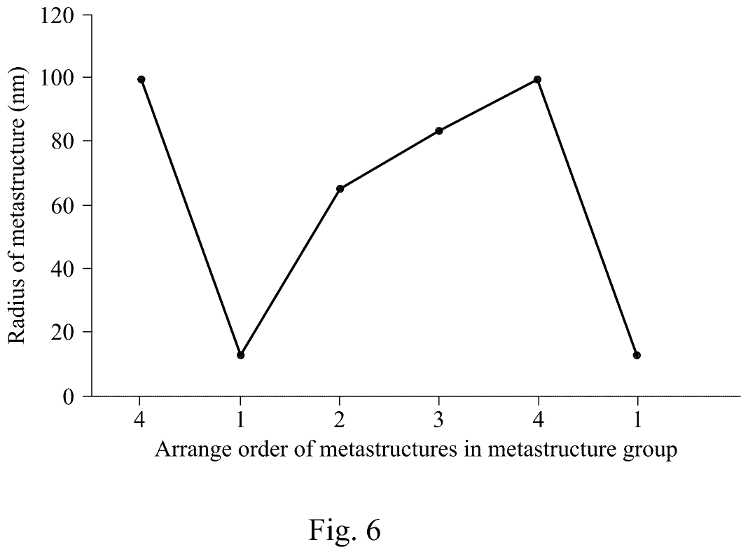

Reference is made to FIG. 6 and Table 3 simultaneously. FIG. 6 is a relationship diagram between the arrange order of metastructures and the radii of metastructures in the metastructure groups of the waveguide plate according to Example 3 of the present disclosure, and Table 3 shows the properties of the waveguide plate of Example 3 and the values of DmMax, QmMax, Hm, Rm, RgMax, RgMin, DmMax×QmMax/1000, Hm/RgMin, Hm/DmMax, RgMax/RgMin, SlopR, Nm, Ns and Sd. In Table 3, “Arrange order of metastructures in metastructure group” refers to the metastructures arranged in order in one metastructure group, and the numbers 1 to 4 represent the four metastructures arranged in order in one metastructure group of Example 3 and the values thereof.

TABLE 3

| Arrange pattern of | Straight line | | | | | |
|---|---|---|---|---|---|---|
| metastructure arrays | | | | | | |
| Relative arrange pattern | Parallel | | | | | |
| of metastructure arrays | | | | | | |
| Arrange | 4 | 1 | 2 | 3 | 4 | 1 |
| order of metastructures | | | | | | |
| in metastructure group | | | | | | |
| Delta phase unit | 0.25 | | | | | |
| variation | | | | | | |
| DmMax (nm) | 260 | 260 | 260 | 260 | 260 | 260 |
| QmMax (unit) | 4 | | | | | |
| Delta phase unit | 0.75 | 0 | 0.25 | 0.5 | 0.75 | 0 |
| Hm (nm) | 600 | 600 | 600 | 600 | 600 | 600 |
| Rm (nm) | 99.8 | 13.0 | 65.2 | 83.6 | 99.8 | 13.0 |
| RgMax (nm) | 99.8 | | | | | |
| RgMin (nm) | 13 | | | | | |
| DmMax × QmMax/1000 | 1.04 | | | | | |
| (nm · unit) | | | | | | |
| Hm/RgMin | 46.2 | | | | | |
| Hm/DmMax | 2.31 | 2.31 | 2.31 | 2.31 | 2.31 | 2.31 |
| RgMax/RgMin | 7.7 | | | | | |
| SlopR (nm/unit) | 28.9 | | | | | |
| Material of | TiO₂ | TiO₂ | TiO₂ | TiO₂ | TiO₂ | TiO₂ |
| metastructure | | | | | | |
| Nm | 2.6142 | 2.6142 | 2.6142 | 2.6142 | 2.6142 | 2.6142 |
| Material of substrate | SiO₂ | SiO₂ | SiO₂ | SiO₂ | SiO₂ | SiO₂ |
| Ns | 1.4585 | 1.4585 | 1.4585 | 1.4585 | 1.4585 | 1.4585 |
| Sd (degrees) | 22.8 | 22.8 | 22.8 | 22.8 | 22.8 | 22.8 |

The wavelength used in waveguide plate of Example 3 is 587.6 nm, and the delta phase unit variation is fixed at 0.25 unit. Therefore, dividing 1 unit by 0.25 can get 4 (1/0.25=4), 1 is divisible by 0.25, thus the numbers of the metastructures of the metastructure groups in one metastructure array of Example 3 are 4, and the maximum number of the metastructures in the metastructure group is 4.

### Example 4

The waveguide plate of Example 4 includes a substrate and at least two metasurfaces. The at least two metasurfaces are disposed on the substrate, each of the metasurfaces includes at least two metastructure arrays, and at least two metastructure arrays are linearly arranged. Each of the metastructure arrays includes at least two metastructure groups, and each of the metastructure groups includes at least two metastructures. Further, the waveguide plate of Example 4 is similar in structure to the waveguide plate 10 of Example 1, and the difference is that the numbers of the metastructures are different. Thus, the details of the structures are referred to the waveguide plate 10 of Example 1, and those will not be described again herein.

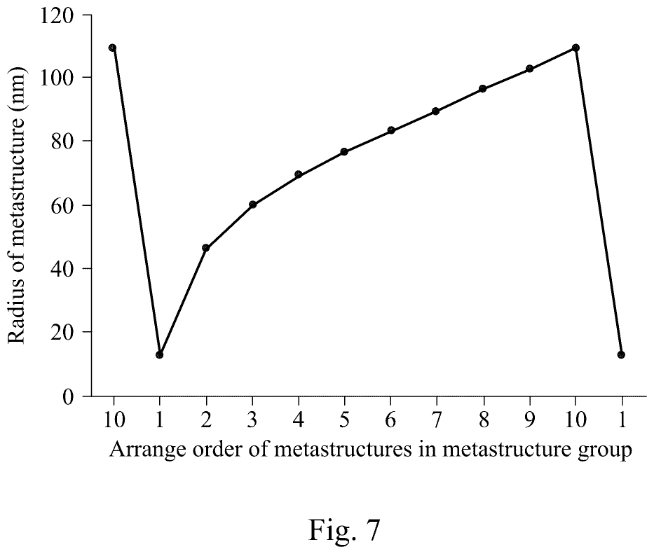

Reference is made to FIG. 7 and Table 4 simultaneously. FIG. 7 is a relationship diagram between the arrange order of metastructures and the radii of metastructures in the metastructure groups of the waveguide plate according to Example 4 of the present disclosure, and Table 4 shows the properties of the waveguide plate of Example 4 and the values of DmMax, QmMax, Hm, Rm, RgMax, RgMin, DmMax×QmMax/1000, Hm/RgMin, Hm/DmMax, RgMax/RgMin, SlopR, Nm, Ns and Sd. In Table 4, “Arrange order of metastructures in metastructure group” refers to the metastructures arranged in order in one metastructure group, and the numbers 1 to 10 represent the ten metastructures arranged in order in one metastructure group of Example 4 and the values thereof.

TABLE 4

| Arrange pattern of | Straight line | | | | | | |
|---|---|---|---|---|---|---|---|
| metastructure arrays | | | | | | | |
| Relative arrange pattern | Parallel | | | | | | |
| of metastructure arrays | | | | | | | |
| Arrange order of | 10 | 1 | 2 | 3 | 4 | 5 | 6 |
| metastructures in | | | | | | | |
| metastructure group | | | | | | | |
| Delta phase unit variation | 0.1 | | | | | | |
| DmMax (nm) | 260 | 260 | 260 | 260 | 260 | 260 | 260 |
| QmMax (unit) | 10 | | | | | | |
| Delta phase unit | 0.9 | 0 | 0.1 | 0.2 | 0.3 | 0.4 | 0.5 |
| Hm (nm) | 600 | 600 | 600 | 600 | 600 | 600 | 600 |
| Rm (nm) | 109.8 | 13.0 | 46.7 | 60.2 | 69.6 | 77.0 | 83.6 |
| RgMax (nm) | 109.8 | | | | | | |
| RgMin (nm) | 13 | | | | | | |
| DmMax × QmMax/1000 | 2.6 | | | | | | |
| (nm · unit) | | | | | | | |
| Hm/RgMin | 46.2 | | | | | | |
| Hm/DmMax | 2.31 | 2.31 | 2.31 | 2.31 | 2.31 | 2.31 | 2.31 |
| RgMax/RgMin | 8.4 | | | | | | |
| SlopR (nm/unit) | 10.8 | | | | | | |
| Material of metastructure | TiO₂ | TiO₂ | TiO₂ | TiO₂ | TiO₂ | TiO₂ | TiO₂ |
| Nm | 2.6142 | 2.6142 | 2.6142 | 2.6142 | 2.6142 | 2.6142 | 2.6142 |
| Material of substrate | SiO₂ | SiO₂ | SiO₂ | SiO₂ | SiO₂ | SiO₂ | SiO₂ |
| Ns | 1.4585 | 1.4585 | 1.4585 | 1.4585 | 1.4585 | 1.4585 | 1.4585 |
| Sd (degrees) | 8.9 | 8.9 | 8.9 | 8.9 | 8.9 | 8.9 | 8.9 |

| Arrange pattern of | Straight line | | | | |
|---|---|---|---|---|---|
| metastructure arrays | | | | | |
| Relative arrange pattern | Parallel | | | | |
| of metastructure arrays | | | | | |
| Arrange order of | 7 | 8 | 9 | 10 | 1 |
| metastructures in | | | | | |
| metastructure group | | | | | |
| Delta phase unit variation | 0.1 | | | | |
| DmMax (nm) | 260 | 260 | 260 | 260 | 260 |
| QmMax (unit) | 10 | | | | |
| Delta phase unit | 0.6 | 0.7 | 0.8 | 0.9 | 0 |
| Hm (nm) | 600 | 600 | 600 | 600 | 600 |
| Rm (nm) | 89.8 | 96.6 | 103.0 | 109.8 | 13.0 |
| RgMax (nm) | 109.8 | | | | |
| RgMin (nm) | 13 | | | | |
| DmMax × QmMax/1000 | 2.6 | | | | |
| (nm · unit) | | | | | |
| Hm/RgMin | 46.2 | | | | |
| Hm/DmMax | 2.31 | 2.31 | 2.31 | 2.31 | 2.31 |
| RgMax/RgMin | 8.4 | | | | |
| SlopR (nm/unit) | 10.8 | | | | |
| Material of metastructure | TiO₂ | TiO₂ | TiO₂ | TiO₂ | TiO₂ |
| Nm | 2.6142 | 2.6142 | 2.6142 | 2.6142 | 2.6142 |
| Material of substrate | SiO₂ | SiO₂ | SiO₂ | SiO₂ | SiO₂ |
| Ns | 1.4585 | 1.4585 | 1.4585 | 1.4585 | 1.4585 |
| Sd (degrees) | 8.9 | 8.9 | 8.9 | 8.9 | 8.9 |

The wavelength used in waveguide plate of Example 4 is 587.6 nm, and the delta phase unit variation is fixed at 0.1 unit. Therefore, dividing 1 unit by 0.1 can get 10 (1/0.1=10), 1 is divisible by 0.1, thus the numbers of the metastructures of the metastructure groups in one metastructure array of Example 4 are 10, and the maximum number of the metastructures in the metastructure group is 10.

### Example 5

The waveguide plate of Example 5 includes a substrate and at least two metasurfaces. The at least two metasurfaces are disposed on the substrate, each of the metasurfaces includes at least two metastructure arrays, and at least two metastructure arrays are linearly arranged. Each of the metastructure arrays includes at least two metastructure groups, and each of the metastructure groups includes at least two metastructures. Further, the waveguide plate of Example 5 is similar in structure to the waveguide plate 10 of Example 1, and the difference is that the numbers of the metastructures are different. Thus, the details of the structures are referred to the waveguide plate 10 of Example 1, and those will not be described again herein.

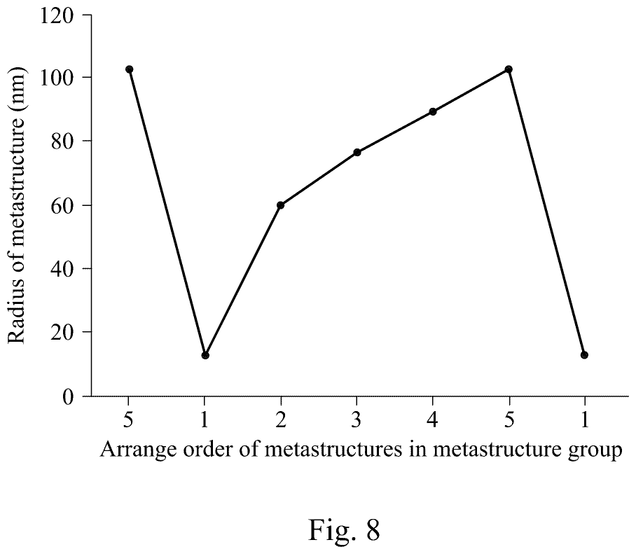

Reference is made to FIG. 8 and Table 5 simultaneously. FIG. 8 is a relationship diagram between the arrange order of metastructures and the radii of metastructures in the metastructure groups of the waveguide plate according to Example 5 of the present disclosure, and Table 5 shows the properties of the waveguide plate of Example 5 and the values of DmMax, QmMax, Hm, Rm, RgMax, RgMin, DmMax×QmMax/1000, Hm/RgMin, Hm/DmMax, RgMax/RgMin, SlopR, Nm, Ns and Sd. In Table 5, “Arrange order of metastructures in metastructure group” refers to the metastructures arranged in order in one metastructure group, and the numbers 1 to 5 represent the five metastructures arranged in order in one metastructure group of Example 5 and the values thereof.

TABLE 5

| Arrange pattern of | Straight line | | | | | | |
|---|---|---|---|---|---|---|---|
| metastructure arrays | | | | | | | |
| Relative arrange pattern | Parallel | | | | | | |
| of metastructure arrays | | | | | | | |
| Arrange order of | 5 | 1 | 2 | 3 | 4 | 5 | 1 |
| metastructures in | | | | | | | |
| metastructure group | | | | | | | |
| Delta phase unit variation | 0.2 | | | | | | |
| DmMax (nm) | 260 | 260 | 260 | 260 | 260 | 260 | 260 |
| QmMax (unit) | 5 | | | | | | |
| Delta phase unit | 0.8 | 0 | 0.2 | 0.4 | 0.6 | 0.8 | 0 |
| Hm (nm) | 600 | 600 | 600 | 600 | 600 | 600 | 600 |
| Rm (nm) | 103.0 | 13.0 | 60.2 | 77.0 | 89.8 | 103.0 | 13.0 |
| RgMax (nm) | 103.0 | | | | | | |
| RgMin (nm) | 13 | | | | | | |
| DmMax × QmMax/1000 | 1.3 | | | | | | |
| (nm · unit) | | | | | | | |
| Hm/RgMin | 46.2 | | | | | | |
| Hm/DmMax | 2.31 | 2.31 | 2.31 | 2.31 | 2.31 | 2.31 | 2.31 |
| RgMax/RgMin | 7.9 | | | | | | |
| SlopR (nm/unit) | 22.5 | | | | | | |
| Material of metastructure | TiO₂ | TiO₂ | TiO₂ | TiO₂ | TiO₂ | TiO₂ | TiO₂ |
| Nm | 2.6142 | 2.6142 | 2.6142 | 2.6142 | 2.6142 | 2.6142 | 2.6142 |
| Material of substrate | SiO₂ | SiO₂ | SiO₂ | SiO₂ | SiO₂ | SiO₂ | SiO₂ |
| Ns | 1.4585 | 1.4585 | 1.4585 | 1.4585 | 1.4585 | 1.4585 | 1.4585 |
| Sd (degrees) | 18.1 | 18.1 | 18.1 | 18.1 | 18.1 | 18.1 | 18.1 |

The wavelength used in waveguide plate of Example 5 is 587.6 nm, and the delta phase unit variation is fixed at 0.2 unit. Therefore, dividing 1 unit by 0.2 can get 5 (1/0.2=5), 1 is divisible by 0.2, thus the numbers of the metastructures of the metastructure groups in one metastructure array of Example 5 are 5, and the maximum number of the metastructures in the metastructure group is 5.

### Example 6

The waveguide plate of Example 6 includes a substrate and at least two metasurfaces. The at least two metasurfaces are disposed on the substrate, each of the metasurfaces includes at least two metastructure arrays, and at least two metastructure arrays are linearly arranged. Each of the metastructure arrays includes at least two metastructure groups, and each of the metastructure groups includes at least two metastructures. Further, the waveguide plate of Example 6 is similar in structure to the waveguide plate 10 of Example 1, and the difference is that the numbers of the metastructures are different. Thus, the details of the structures are referred to the waveguide plate 10 of Example 1, and those will not be described again herein.

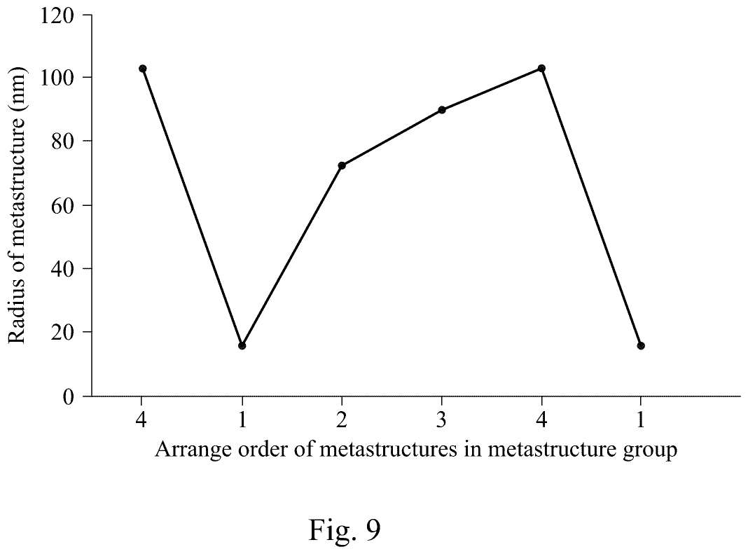

Reference is made to FIG. 9 and Table 6 simultaneously. FIG. 9 is a relationship diagram between the arrange order of metastructures and the radii of metastructures in the metastructure groups of the waveguide plate according to Example 6 of the present disclosure, and Table 6 shows the properties of the waveguide plate of Example 6 and the values of DmMax, QmMax, Hm, Rm, RgMax, RgMin, DmMax×QmMax/1000, Hm/RgMin, Hm/DmMax, RgMax/RgMin, SlopR, Nm, Ns and Sd. In Table 6, “Arrange order of metastructures in metastructure group” refers to the metastructures arranged in order in one metastructure group, and the numbers 1 to 4 represent the four metastructures arranged in order in one metastructure group of Example 6 and the values thereof.

TABLE 6

| Arrange pattern of | Straight line | | | | | |
|---|---|---|---|---|---|---|
| metastructure arrays | | | | | | |
| Relative arrange pattern | Parallel | | | | | |
| of metastructure arrays | | | | | | |
| Arrange order of | 4 | 1 | 2 | 3 | 4 | 1 |
| metastructures in | | | | | | |
| metastructure group | | | | | | |
| Delta phase unit variation | 0.25 | | | | | |
| DmMax (nm) | 320 | 320 | 320 | 320 | 320 | 320 |
| QmMax (unit) | 4 | | | | | |
| Delta phase unit | 0.75 | 0 | 0.25 | 0.5 | 0.75 | 0 |
| Hm (nm) | 600 | 600 | 600 | 600 | 600 | 600 |
| Rm (nm) | 103.5 | 16.0 | 72.9 | 90.4 | 103.5 | 16.0 |
| RgMax (nm) | 103.5 | | | | | |
| RgMin (nm) | 16 | | | | | |
| DmMax × QmMax/1000 | 1.28 | | | | | |
| (nm · unit) | | | | | | |
| Hm/RgMin | 37.5 | | | | | |
| Hm/DmMax | 1.88 | 1.88 | 1.88 | 1.88 | 1.88 | 1.88 |
| RgMax/RgMin | 6.5 | | | | | |
| SlopR (nm/unit) | 29.2 | | | | | |
| Material of metastructure | TiO₂ | TiO₂ | TiO₂ | TiO₂ | TiO₂ | TiO₂ |
| Nm | 2.6142 | 2.6142 | 2.6142 | 2.6142 | 2.6142 | 2.6142 |
| Material of substrate | SiO² | SiO² | SiO² | SiO² | SiO² | SiO₂ |
| Ns | 1.4585 | 1.4585 | 1.4585 | 1.4585 | 1.4585 | 1.4585 |
| Sd (degrees) | 18.3 | 18.3 | 18.3 | 18.3 | 18.3 | 18.3 |

The wavelength used in waveguide plate of Example 6 is 587.6 nm, and the delta phase unit variation is fixed at 0.25 unit. Therefore, dividing 1 unit by 0.25 can get 4 (1/0.25=4), 1 is divisible by 0.25, thus the numbers of the metastructures of the metastructure groups in one metastructure array of Example 6 are 4, and the maximum number of the metastructures in the metastructure group is 4.

### Example 7

The waveguide plate of Example 7 includes a substrate and at least two metasurfaces. The at least two metasurfaces are disposed on the substrate, each of the metasurfaces includes at least two metastructure arrays, and at least two metastructure arrays are linearly arranged. Each of the metastructure arrays includes at least two metastructure groups, and each of the metastructure groups includes at least two metastructures. Further, the waveguide plate of Example 7 is similar in structure to the waveguide plate 10 of Example 1, and the difference is that the numbers of the metastructures are different. Thus, the details of the structures are referred to the waveguide plate 10 of Example 1, and those will not be described again herein.

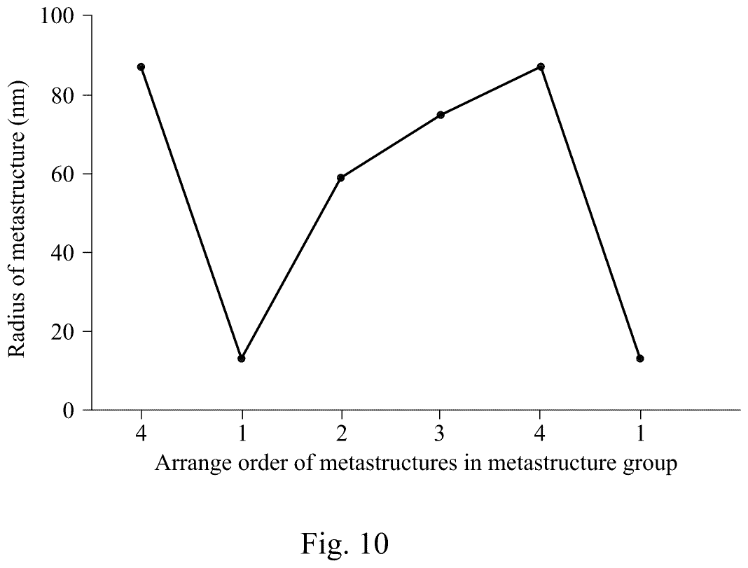

Reference is made to FIG. 10 and Table 7 simultaneously. FIG. 10 is a relationship diagram between the arrange order of metastructures and the radii of metastructures in the metastructure groups of the waveguide plate according to Example 7 of the present disclosure, and Table 7 shows the properties of the waveguide plate of Example 7 and the values of DmMax, QmMax, Hm, Rm, RgMax, RgMin, DmMax×QmMax/1000, Hm/RgMin, Hm/DmMax, RgMax/RgMin, SlopR, Nm, Ns and Sd. In Table 7, “Arrange order of metastructures in metastructure group” refers to the metastructures arranged in order in one metastructure group, and the numbers 1 to 4 represent the four metastructures arranged in order in one metastructure group of Example 7 and the values thereof.

TABLE 7

| Arrange pattern of | Straight line | | | | | |
|---|---|---|---|---|---|---|
| metastructure arrays | | | | | | |
| Relative arrange pattern | Parallel | | | | | |
| of metastructure arrays | | | | | | |
| Arrange order of | 4 | 1 | 2 | 3 | 4 | 1 |
| metastructures in | | | | | | |
| metastructure group | | | | | | |
| Delta phase unit variation | 0.25 | | | | | |
| DmMax (nm) | 260 | 260 | 260 | 260 | 260 | 260 |
| QmMax (unit) | 4 | | | | | |
| Delta phase unit | 0.75 | 0 | 0.25 | 0.5 | 0.75 | 0 |
| Hm (nm) | 800 | 800 | 800 | 800 | 800 | 800 |
| Rm (nm) | 87.3 | 13.0 | 59.0 | 75.1 | 87.3 | 13.0 |
| RgMax (nm) | 87.3 | | | | | |
| RgMin (nm) | 13 | | | | | |
| DmMax × QmMax/1000 | 1.04 | | | | | |
| (nm · unit) | | | | | | |
| Hm/RgMin | 61.5 | | | | | |
| Hm/DmMax | 3.08 | 3.08 | 3.08 | 3.08 | 3.08 | 3.08 |
| RgMax/RgMin | 6.7 | | | | | |
| SlopR (nm/unit) | 24.8 | | | | | |
| Material of metastructure | TiO₂ | TiO₂ | TiO₂ | TiO₂ | TiO₂ | TiO₂ |
| Nm | 2.6142 | 2.6142 | 2.6142 | 2.6142 | 2.6142 | 2.6142 |
| Material of substrate | SiO₂ | SiO₂ | SiO₂ | SiO₂ | SiO₂ | SiO₂ |
| Ns | 1.4585 | 1.4585 | 1.4585 | 1.4585 | 1.4585 | 1.4585 |
| Sd (degrees) | 22.8 | 22.8 | 22.8 | 22.8 | 22.8 | 22.8 |

The wavelength used in waveguide plate of Example 6 is 587.6 nm, and the delta phase unit variation is fixed at 0.25 unit. Therefore, dividing 1 unit by 0.25 can get 4 (1/0.25=4), 1 is divisible by 0.25, thus the numbers of the metastructures of the metastructure groups in one metastructure array of Example 7 are 4, and the maximum number of the metastructures in the metastructure group is 4.

### Example 8

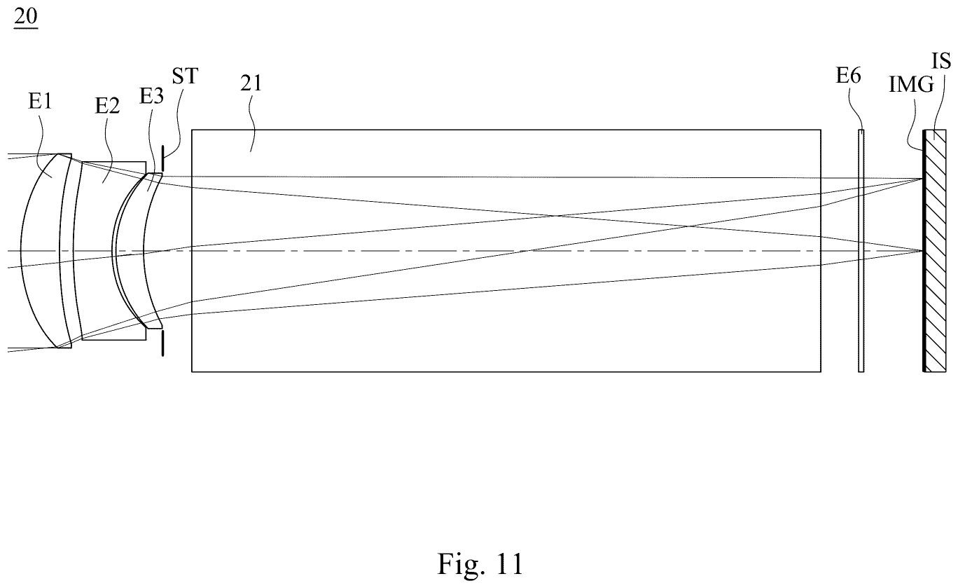

Reference is made to FIG. 11, which is a schematic view of an optical lens assembly 20 according to Example 8 of the present disclosure. The optical lens assembly 20 includes, in order from an object side to an image side of an optical path, a first optical lens element E1, a second optical lens element E2, a third optical lens element E3, a stop ST, a waveguide plate 21, a first filter E6 and an image surface IMG, and an image sensor IS is disposed on the image surface IMG of the optical lens assembly 20.

In FIG. 11, the waveguide plate 21 is presented in the form of a straight-line expansion of the light path, and the waveguide plate 21 is disposed on an image side of the third optical lens element E3 so as to replace the prism disposed between the third optical lens element E3 and the image surface IMG. Further, the waveguide plate 21 can be the aforementioned waveguide plates of Example 1 to Example 7, and the details of the same structures will not be described again herein.

Reference is further made to Table 8, which shows the values of the parameters of the optical lens assembly 20 of Example 8. In Table 8, FOV is a field of view of the optical lens assembly 20, AOI is an angle of incidence on the waveguide plate 21 of the optical lens assembly 20, F is a total focal length of the optical lens assembly 20, F1 is a focal length of the first optical lens element E1, F2 is a focal length of the second optical lens element E2, F3 is a focal length of the third optical lens element E3, POW1 is a refractive power of the first optical lens element E1, POW2 is a refractive power of the second optical lens element E2, POW3 is a refractive power of the third optical lens element E3, R1 is a curvature radius of an object-side surface of the first optical lens element E1, R2 is a curvature radius of an image-side surface of the first optical lens element E1, R3 is a curvature radius of an object-side surface of the second optical lens element E2, R4 is a curvature radius of an image-side surface of the second optical lens element E2, R5 is a curvature radius of an object-side surface of the third optical lens element E3, R6 is a curvature radius of an image-side surface of the third optical lens element E3, and BL is a back focal length of the optical lens assembly 20.

TABLE 8

| | |
|---|---|
| FOV (degrees) | 11.8 |
| AOI (degrees) | 8.55 |
| Number of | 3 |
| optical lens elements | |
| F (mm) | 29.02 |
| F1 (mm) | 19.05 |
| F2 (mm) | −11.33 |
| F3 (mm) | 14.70 |
| POW1 (F/F1) | 1.52 |
| POW2 (F/F2) | −2.56 |
| POW3 (F/F3) | 1.97 |
| R1 (mm) | 6.50 |
| R2 (mm) | 14.92 |
| R3 (mm) | 15.23 |
| R4 (mm) | 4.58 |
| R5 (mm) | 4.54 |
| R6 (mm) | 6.54 |
| BL (mm) | 32.29 |
| R1/R2 | 0.44 |
| R3/R4 | 3.32 |
| R5/R6 | 0.69 |
| F/BL | 0.90 |

If the definitions of parameters shown in tables of the following examples are the same as those shown in Table 8, those will not be described again.

### Example 9

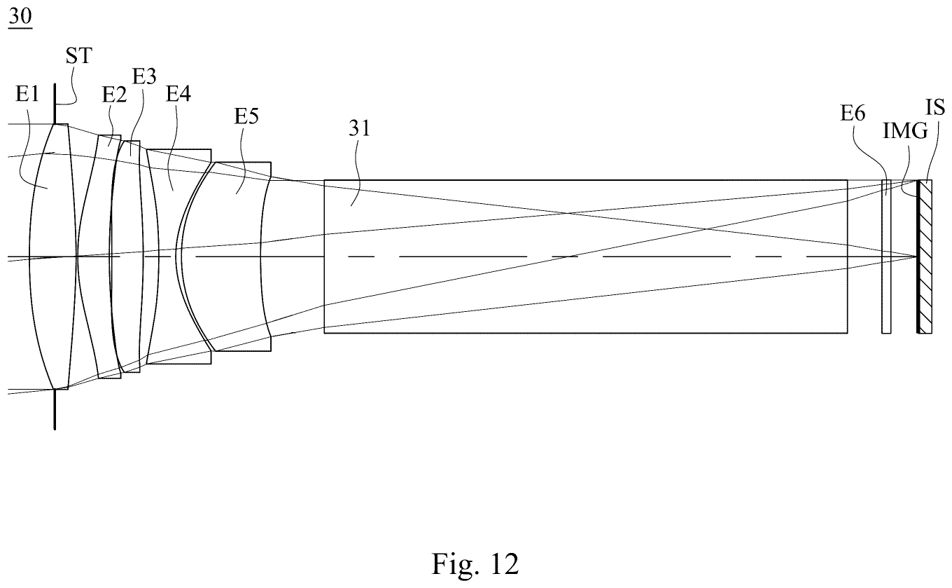

Reference is made to FIG. 12, which is a schematic view of an optical lens assembly 30 according to Example 9 of the present disclosure. The optical lens assembly 30 includes, in order from an object side to an image side of an optical path, a first optical lens element E1, a stop ST, a second optical lens element E2, a third optical lens element E3, a fourth optical lens element E4, a fifth optical lens element E5, a waveguide plate 31, a first filter E6 and an image surface IMG, and an image sensor IS is disposed on the image surface IMG of the optical lens assembly 30.

In FIG. 12, the waveguide plate 31 is presented in the form of a straight-line expansion of the light path, and the waveguide plate 31 is disposed on an image side of the fifth optical lens element E5 so as to replace the prism disposed between the fifth optical lens element E5 and the image surface IMG. Further, the waveguide plate 31 can be the aforementioned waveguide plates of Example 1 to Example 7, and the details of the same structures will not be described again herein.

Reference is made to Table 9, which shows the values of FOV, AOI, the number of the optical lens elements, F, F1, F2, F3, F4, F5, POW1, POW2, POW3, POW4, POW5, R1, R2, R3, R4, R5, R6, R7, R8, R9, R10, BL, R1/R2, R3/R4, R5/R6, R7/R8, R9/R10 and F/BL of the optical lens assembly 30 of Example 9, wherein F4 is a focal length of the fourth optical lens element E4, F5 is a focal length of the fifth optical lens element E5, POW4 is a refractive power of the fourth optical lens element E4, POW5 is a refractive power of the fifth optical lens element E5, R7 is a curvature radius of an object-side surface of the fourth optical lens element E4, R8 is a curvature radius of an image-side surface of the fourth optical lens element E4, R9 is a curvature radius of an object-side surface of the fifth optical lens element E5, and R10 is a curvature radius of an image-side surface of the fifth optical lens element E5.

TABLE 9

| | |
|---|---|
| FOV (degrees) | 11.2 |
| AOI (degrees) | 7.53 |
| Number of | 5 |
| optical lens elements | |
| F (mm) | 18.31 |
| F1 (mm) | 12.06 |
| F2 (mm) | 13.60 |
| F3 (mm) | 51.91 |
| F4 (mm) | −3.22 |
| F5 (mm) | 6.76 |
| POW1 (F/F1) | 1.52 |
| POW2 (F/F2) | 1.35 |
| POW3 (F/F3) | 0.35 |
| POW4 (F/F4) | −5.68 |
| POW5 (F/F5) | 2.71 |
| R1 (mm) | 12.17 |
| R2 (mm) | −13.78 |
| R3 (mm) | 4.94 |
| R4 (mm) | 14.06 |
| R5 (mm) | −42.24 |
| R6 (mm) | −16.77 |
| R7 (mm) | −12.32 |
| R8 (mm) | 2.50 |
| R9 (mm) | 3.61 |
| R10 (mm) | 13.25 |
| BL (mm) | 15.46 |
| R1/R2 | −0.88 |
| R3/R4 | 0.35 |
| R5/R6 | 2.52 |
| R7/R8 | −4.93 |
| R9/R10 | 0.27 |
| F/BL | 1.18 |

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A waveguide plate, comprising:
a substrate; and
at least two metasurfaces disposed on the substrate, wherein each of the at least two metasurfaces comprises at least two metastructure arrays, and the at least two metastructure arrays are linearly arranged;
wherein each of the at least two metastructure arrays comprises at least two metastructure groups, each of the at least two metastructure groups comprises at least two metastructures, and each of the at least two metastructures is columnar;
wherein a maximum adjacent center distance between the at least two metastructures is DmMax, a maximum number of the metastructures in each of the metastructure groups is QmMax, and the following condition is satisfied:
$$DmMax \times QmMax / 1000 \leq 3 nm \cdot unit .$$

2. The waveguide plate of claim 1, wherein a height of each of the metastructures is Hm, a minimum metastructure radius of each of the metastructure groups is RgMin, and the following condition is satisfied:
$$4.7 \leq Hm / RgMin .$$

3. The waveguide plate of claim 1, wherein a height of each of the metastructures is Hm, the maximum adjacent center distance between the at least two metastructures is DmMax, and the following condition is satisfied:
1.75<Hm/Dm Max.

4. The waveguide plate of claim 1, wherein a maximum metastructure radius of each of the metastructure groups is RgMax, a minimum metastructure radius of each of the metastructure groups is RgMin, and the following condition is satisfied:
$$1 \leq RgMax / RgMin \leq 15.$$

5. The waveguide plate of claim 1, wherein a slope of radius of each of the metastructure groups is SlopR, and the following condition is satisfied:
$$1 nm / unit \leq SlopR \leq 50 nm / unit .$$

6. The waveguide plate of claim 1, wherein a refractive index of the substrate is Ns, and the following condition is satisfied:
Ns≤1.6.

7. The waveguide plate of claim 1, wherein a deflection angle of passing light of each of the metasurfaces is Sd, and the following condition is satisfied:
5 degrees≤Sd.

8. An optical lens assembly, comprising:
the waveguide plate of claim 1.

9. The optical lens assembly of claim 8, further comprising:
at least three optical lens elements, wherein the waveguide plate is disposed on an image side of the last one of the optical lens elements from an object side to an image side of an optical path.

10. The optical lens assembly of claim 8, wherein a field of view of the optical lens assembly is FOV, and the following condition is satisfied:
FOV≤40 degrees.

11. The optical lens assembly of claim 8, wherein an angle of incidence on the waveguide plate of the optical lens assembly is AOI, and the following condition is satisfied:
AOI≤30 degrees.

12. The optical lens assembly of claim 8, wherein a total focal length of the optical lens assembly is F, a back focal length of the optical lens assembly is BL, and the following condition is satisfied:
$$F / BL \leq 1.3 .$$

13. An electronic device, comprising:
the optical lens assembly of claim 8.

14. A waveguide plate, comprising:
a substrate; and
at least two metasurfaces disposed on the substrate, wherein each of the at least two metasurfaces comprises at least two metastructure arrays, and the at least two metastructure arrays are linearly arranged;
wherein each of the at least two metastructure arrays comprises at least two metastructure groups, and each of the at least two metastructure groups comprises at least two metastructures;
wherein a height of each of the metastructures is Hm, a refractive index of the substrate is Ns, and the following conditions are satisfied:
400 nm<Hm; and
Ns≤1.6.

15. The waveguide plate of claim 14, wherein a maximum adjacent center distance between the at least two metastructures is DmMax, a maximum number of the metastructures in each of the metastructure groups is QmMax, and the following condition is satisfied:
$$DmMax \times QmMax / 1000 \leq 2 nm \cdot unit .$$

16. The waveguide plate of claim 15, wherein the height of each of the metastructures is Hm, a minimum metastructure radius of each of the metastructure groups is RgMin, and the following condition is satisfied:
$$30 \leq Hm / RgMin \leq 70.$$

17. The waveguide plate of claim 16, wherein the height of each of the metastructures is Hm, the maximum adjacent center distance between the at least two metastructures is DmMax, and the following condition is satisfied:
$$2 \leq Hm / DmMax .$$

18. The waveguide plate of claim 17, wherein a maximum metastructure radius of each of the metastructure groups is RgMax, the minimum metastructure radius of each of the metastructure groups is RgMin, and the following condition is satisfied:
$$5 \leq RgMax / RgMin \leq 9 .$$

19. The waveguide plate of claim 18, wherein a slope of radius of each of the metastructure groups is SlopR, and the following condition is satisfied:
$$20 nm / unit \leq SlopR \leq 30 nm / unit .$$

20. The waveguide plate of claim 14, wherein a deflection angle of passing light of each of the metasurfaces is Sd, and the following condition is satisfied:
10 degrees≤Sd.

21. An optical lens assembly, comprising:
the waveguide plate of claim 14.

22. The optical lens assembly of claim 21, further comprising:
at least three optical lens elements, wherein the waveguide plate is disposed on an image side of the last one of the optical lens elements from an object side to an image side of an optical path.

23. The optical lens assembly of claim 22, wherein a field of view of the optical lens assembly is FOV, and the following condition is satisfied:
FOV≤40 degrees.

24. The optical lens assembly of claim 23, wherein an angle of incidence on the waveguide plate of the optical lens assembly is AOI, and the following condition is satisfied:
AOI≤30 degrees.

25. The optical lens assembly of claim 21, further comprising:
five optical lens elements, the five optical lens elements being, in order from an object side to an image side of an optical path, a first optical lens element, a second optical lens element, a third optical lens element, a fourth optical lens element and a fifth optical lens element;
wherein a maximum adjacent center distance between the at least two metastructures is DmMax, a maximum number of the metastructures in each of the metastructure groups is QmMax, the height of each of the metastructures is Hm, a minimum metastructure radius of each of the metastructure groups is RgMin, a slope of radius of each of the metastructure groups is SlopR, a deflection angle of passing light of each of the metasurfaces is Sd, a field of view of the optical lens assembly is FOV, an angle of incidence on the waveguide plate of the optical lens assembly is AOI, a total focal length of the optical lens assembly is F, a back focal length of the optical lens assembly is BL, a curvature radius of an object-side surface of the first optical lens element is R1, a curvature radius of an image-side surface of the first optical lens element is R2, a curvature radius of an object-side surface of the second optical lens element is R3, a curvature radius of an image-side surface of the second optical lens element is R4, a curvature radius of an object-side surface of the third optical lens element is R5, a curvature radius of an image-side surface of the third optical lens element is R6, a curvature radius of an object-side surface of the fourth optical lens element is R7, a curvature radius of an image-side surface of the fourth optical lens element is R8, a curvature radius of an object-side surface of the fifth optical lens element is R9, a curvature radius of an image-side surface of the fifth optical lens element is R10, and the following conditions are satisfied:
$$0 nm - unit < DmMax \times QmMax / 1000 \leq 1.1 nm - unit ;$$
$$45 \leq Hm / RgMin \leq 50 ;$$
$$25 nm / unit \leq SlopR \leq 30 nm / unit ;$$
$$15 degrees \leq Sd ;$$
$$FOV \leq 15 degrees ;$$
$$AOI \leq 10 degress ;$$
$$0 < F / BL \leq 1 ;$$
$$\vert R 1 / R 2 \vert \leq 5 ;$$
$$\vert R 3 / R 4 \vert \leq 5 ;$$
$$\vert R 5 / R 6 \vert \leq 5 ;$$
$$\vert R 7 / R 8 \vert \leq 5 ; and$$
$$\vert R 9 / R 10 \vert \leq 5.$$

26. An electronic device, comprising:
the optical lens assembly of claim 21.
